(19) United States
(12) Patent Application Publication
(10) Pub. No.: US 2012/0149386 A1
(43) Pub. Date: Jun. 14, 2012

(54) RADIO COMMUNICATION APPARATUS AND RADIO COMMUNICATION METHOD

(75) Inventors: Swaroop Sampath Kumar, Singapore (SG); Pek Yew Tan, Singapore (SG); Terufumi Takada, Kanagawa (JP)

(73) Assignee: PANASONIC CORPORATION, Osaka (JP)

(21) Appl. No.: 13/390,303

(22) PCT Filed: Aug. 12, 2010
(86) PCT No.: PCT/JP2010/005057

§ 371 Date: Feb. 13, 2012

(30) Foreign Application Priority Data
Aug. 19, 2009 (JP) 2009-190212

(51) Int. Cl. H04W 72/02

(52) U.S. Cl. 455/452.2

(57) ABSTRACT

Provided is a radio communication apparatus capable of reducing power consumption of user equipment by improving efficiency in the use of radio resources even in a case when a network node and the user equipment hold a plurality of bearer contexts shared therebetween. The apparatus comprises an information determination unit (101), a QoS determination unit (102) and a control unit (104). The information determination unit (101) determines whether the type of information to be transmitted is signaling or data. When the above type is data, the QoS determination unit (102) determines, on the basis of the QoS for the information to be transmitted, whether or not the information to be transmitted requires real-time transmission. When the above type is signaling, the control unit (104) selects a first establishment method for establishing just a signaling connection, without establishing a radio bearer, between the apparatus and a communication counterpart thereof. When the above type is data, the control unit (104) selects, on the basis of the result of the determination by the QoS determination unit (102), either a second establishment method for establishing radio bearers such that highest priority is given to achieving a high speed of the establishment, or a third establishment method for establishing radio bearers such that highest priority is given to achieving high efficiency in the use of radio resources.

### TECHNICAL FIELD

The present invention relates to a radio communication apparatus and a radio communication method.

### BACKGROUND ART

A portable terminal apparatus such as a portable telephone (hereinafter, “UE: User Equipment) is designed to save power consumption in an idle mode in a waiting state. During the idle mode, the UE waits until when there arises a request for transmitting data (uplink data) or signaling (uplink signaling) from the own apparatus. Alternatively, when information for notifying presence of data (downlink data) or of signaling (downlink signaling) that is destined to the UE arrives at the network side, the UE waits until receiving paging information that is transmitted from a network side to the UE.

In the third-generation mobile communication system (hereinafter, “3G”), the UE transmits a request message (Service request) for establishing a wireless connection with a network node (also called a network entity. For example SGSN: Serving General Packet Radio Service Support Node). The service request includes an information element (a service type) that indicates an object of requesting establishment of a wireless connection. The service type indicates, for example, whether the object of establishing a wireless connection is a transmission of uplink signaling (service type: signaling) or a transmission of uplink data (service type: data). The service type is one-byte information, for example.

Further, the service request includes an uplink data status as an information element that indicates which communication path (hereinafter, “Radio Bearer”) should be established, based on an application for transmitting the uplink data. The uplink data status is information of four octets, for example. Each radio bearer is expressed by a Bearer Context as information concerning the radio bearer that includes a bearer ID, a QoS (Quality of Service), etc., for example.

On the other hand, in LTE/SAE (Long Term Evolution/System Architecture Evolution) (hereinafter, simply “LTE”) as the next-generation mobile communication system, when the UE is in the idle mode, and when a transmission of uplink data relevant to a certain application becomes necessary, it is required to quickly establish a signaling connection for transmitting/receiving signaling concerning this application and a data radio bearer for transmitting/receiving data. Therefore, in the LTE, it has been studied to make a message size of the service request small by decreasing information elements of the service request. Further, in the LTE, it has been determined that the service request occupies only 32 bits and that the service type and the uplink data status described above are not used (for example, refer to NPL 1).

### CITATION LIST

### Non-Patent Literature

### NPL1

3GPP TS 24.301 V8.1.0, “Non-Access-Stratum (NAS) protocol for Evolved Packet System (EPS); Stage 3 (Release 8),” March 2009

### SUMMARY OF INVENTION

### Technical Problem

In this case, bearer contexts corresponding to radio bearers that are previously established between the network node and the UE are shared and held in the network node and the UE. Therefore, in the 3G, the network node specifies a bearer context corresponding to a service request, based on a service type and an uplink data status that are included in the service request transmitted from the UE, and establishes a radio bearer following the specified bearer context. However, in the LTE, as described above, the service type and the uplink data status are not included in the service request. Therefore, the network node cannot recognize whether the service request that is transmitted from the UE is a request for establishing a connection to the uplink signaling, or a request for establishing a radio bearer to the uplink data. That is, the network node cannot specify which radio bearer should be established, even when the network node receives a service request from the UE.

Then, in the LTE, when the network node and the UE share and hold a plurality of bearer contexts, the network node establishes radio bearers corresponding to all bearer contexts each time when receiving a service request from the UE. As a result, a radio bearer can be quickly established. However, in this case, the network node establishes all data radio bearers, each time when the UE transmits a request for establishing a signaling connection and a request for establishing a data radio bearer. That is, unnecessary radio bearers may be established, each time when a service request is transmitted.

Further, at a time of deleting bearer contexts that are shared and held by the network node and the UE, the UE transmits a service request to synchronize the UE and the network node. That is, even at a time of deleting only a specific bearer context, radio bearers corresponding to all bearer contexts that the network node and the UE share and hold are established.

As described above, in the LTE, when a service request is transmitted to transmit/receive signaling or data, or to delete bearer contexts, all radio bearers corresponding to a plurality of bearer contexts that the network node and the UE share and hold are established. After there are no communications between the network node and the UE, the radio bearers are not released until when a time set in advance elapses. Therefore, even when only a specific radio bearer is established, all radio bearers are kept in an established state, that is, useless radio bearers remain in the established state. As a result, efficiency in the use of radio resources becomes poor, and power consumption of the UE becomes large.

An object of the present invention is to provide a radio communication apparatus and a radio communication method capable of improving efficiency in the use of radio resources, and capable of reducing power consumption of the UE, even when the network node and the UE share and hold a plurality of bearer contexts.

### Solution to Problem

A radio communication apparatus according to the present invention is a radio communication apparatus in a radio communication system that performs a transmission/reception of data by establishing a radio bearer, and includes a first deciding section that decides whether a type of transmission information is signaling or data, a second deciding section that decides whether a real-time characteristic is required in the transmission information, based on a QoS of the transmission information, when the type is data, and a selecting section that selects a first establishing method of establishing only a connection of the signaling without establishing the radio bearer between the own apparatus and the other communication apparatus, when the type is signaling, and selects either a second establishing method of establishing the radio bearer that can obtain an establishment speed with first priority or a third establishing method of establishing the radio bearer that can obtain efficiency in the use of a radio resource with first priority, based on a result of the decision by the second deciding section, when the type is data.

A radio communication method according to the present invention is a radio communication method in a radio communication apparatus that performs a transmission/reception of data by establishing a radio bearer, and includes a first deciding step of deciding whether a type of transmission information is signaling or data, a second deciding step of deciding whether a real-time characteristic is required in the transmission information, based on a QoS of the transmission information, when the type is data, and a selecting step of selecting a first establishing method of establishing only a connection of the signaling without establishing the radio bearer between the radio communication apparatus and the other communication apparatus, when the type is signaling, and selecting either a second establishing method of establishing the radio bearer that can obtain an establishment speed with first priority or a third establishing method of establishing the radio bearer that can obtain efficiency in the use of a radio resource with first priority, based on a result of the decision at the second deciding step, when the type is data.

### Advantageous Effects of Invention

According to the present invention, it is possible to improve efficiency of the use of a radio resource and reduce power consumption of a UE, even when a network node and the UE share and hold a plurality of bearer contexts.

### BRIEF DESCRIPTION OF DRAWINGS

FIG. 1 is a block diagram showing a configuration of a UE according to Embodiment 1 of the present invention;

FIG. 2 is a block diagram showing a configuration of a network node according to Embodiment 1 of the present invention;

FIG. 3 shows a service request transmission process in the UE according to Embodiment 1 of the present invention;

FIG. 4 shows a radio bearer establishment process in the network node according to Embodiment 1 of the present invention;

FIG. 5 is a block diagram showing a configuration of a UE according to Embodiment 2 of the present invention;

FIG. 6 is a block diagram showing a configuration of a network node according to Embodiment 2 of the present invention;

FIG. 7 shows a paging information transmission process in the network node according to Embodiment 2 of the present invention; and

FIG. 8 shows a service request transmission process in the UE according to Embodiment 2 of the present invention.

### DESCRIPTION OF EMBODIMENTS

Hereinafter, embodiments of the present invention is explained in detail with reference to the appended drawings.

In a radio communication system according to the present embodiments, a UE transmits a service request to a network node, thereby establishing a radio bearer that performs a transmission/reception of data.

In the following explanation, four kinds of service requests are used as a service request that the UE transmits. A first service request is a “signaling service request” that includes only instruction information for requesting establishment of a signaling connection. That is, the signaling service request has a purpose of only notifying a request for establishing a signaling connection.

A second service request is a “normal service request” for requesting establishment of all radio bearers corresponding to bearer contexts that the network node and the UE share and hold. That is, the normal service request is the same as a service request used in the LTE, for example. Therefore, when the network node receives the normal service request, the network node immediately establishes all radio bearers corresponding to a plurality of bearer contexts that are held by the UE and the network node. That is, the normal service request is generated when requesting a method of establishing a radio bearer of which an establishment speed can be obtained with first priority.

A third service request is an “extended service request” that includes a data status including information concerning uplink data or downlink data (for example, a bearer ID that indicates a radio bearer corresponding to uplink data or downlink data). The network node that receives the extended service request can specify a bearer ID of a radio bearer which the UE requests to establish. The extended service request is generated when requesting a method of establishing a radio bearer that can obtain efficiency of the use of a radio resource with first priority.

A fourth service request is a “default bearer service request” that includes only instruction information for requesting establishment of a radio bearer that is set in advance between the network node and the UE. For example, among a plurality of radio bearers corresponding to bearer contexts that the network node and the UE share and hold, any one of radio bearers is set in advance as a default bearer. For example, a radio bearer that is usually used at a communication start time is set as a default bearer.

### Embodiment 1

In the present embodiment, a case where uplink information (uplink signaling or uplink data) is generated in the UE is explained. That is, the UE transmits to the network node, a service request for requesting establishment of a connection of uplink information that is in a transmission waiting state.

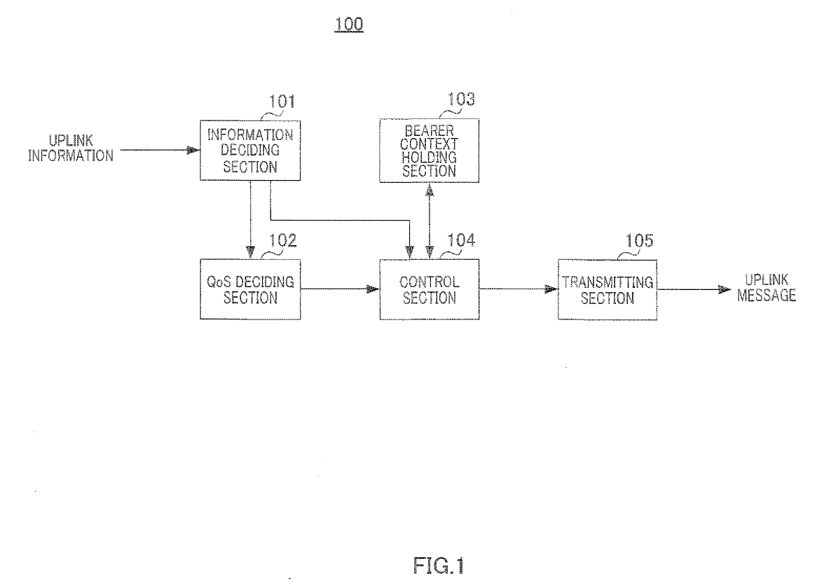

FIG. 1 shows a configuration of the UE according to the present embodiment. In the present embodiment, UE 100 shown in FIG. 1 is a radio communication apparatus according to the present invention. In UE 100 shown in FIG. 1, information deciding section 101, decides whether input uplink information, that is, uplink information in a transmission waiting state is uplink signaling or uplink data. Then, when the uplink information is uplink signaling, information deciding section 101 outputs information that indicates that the uplink signaling is in the transmission waiting state, to control section 104. On the other hand, when the uplink information is uplink data, information deciding section 101 outputs information that indicates that the uplink data is in the transmission waiting state, to QoS deciding section 102.

When the information indicating that the uplink data is in the transmission waiting state is input from information deciding section 101, QoS deciding section 102 decides whether a real-time characteristic is required in the uplink data, based on the QoS of the uplink data. As an example, when the uplink data is IP data (an IP packet), QoS deciding section 102 decides whether a real-time characteristic is required in the uplink data, for an example by referring to a service type (TOS: Type of Service) field of the IP packet (the uplink data). QoS deciding section 102 outputs to control section 104 QoS, information that indicates a result of the decision about whether a real-time characteristic is required in the uplink data.

Bearer context holding section 103 holds a bearer context as information that includes the bearer ID, the QoS and the like of each radio bearer. Bearer context holding section 103 shares a plurality of bearer contexts between the network node and the own apparatus. For example, bearer context holding section 103 holds bearer contexts corresponding to radio bearers that the own apparatus has established before.

Control section 104 generates a service request to be transmitted to the network node, based on information that is input from information deciding section 101 or QoS deciding section 102. Specifically, control section 104 generates the signaling service request, when information indicating that the uplink signaling is in the transmission waiting state is input from information deciding section 101.

On the other hand, control section 104 decides that the uplink data is in the transmission waiting state, when the QoS information is input from QoS deciding section 102. Then, control section 104 generates any one of the normal service request and the extended service request, based on the QoS information (that is, a result of the decision about whether the uplink data requires a real-time characteristic). Specifically, control section 104 generates the normal service request, when a real-time characteristic is required in the uplink data. On the other hand, when a real-time characteristic is not required in the uplink data, control section 104 further refers to bearer context holding section 103, and specifies a bearer context with (to) which the uplink data is associated (mapped). For example, control section 104 specifies a bearer context with which the uplink data is associated, by using a filter that identifies which data is associated with which radio bearer. For example, control section 104 uses an IF address of a transmission source or a transmission destination of the uplink data, or a port address of a transmission source or a transmission destination of the uplink data, as the filter.

After specifying a bearer context with which the uplink is associated, control section 104 decides whether the number of bearer contexts other than the specified bearer context (hereinafter, “other bearer contexts”) is larger than a threshold value that is set in advance. When the number of the other bearer contexts is larger than the threshold value that is set in advance (that is, there are many wasteful radio resources), control section 104 generates the extended service request that includes a data status including the bearer ID that is shown in the bearer context with which the uplink data is associated. On the other hand, when the number of the other bearer contexts is equal to or smaller than the threshold value that is set in advance (that is, there are few wasteful radio resources), control section 104 generates the normal service request. Then, control section 104 outputs the generated service request to transmitting section 105 as an uplink message.

Control section 105 transmits the uplink message that is input from control section 104, to the network node.

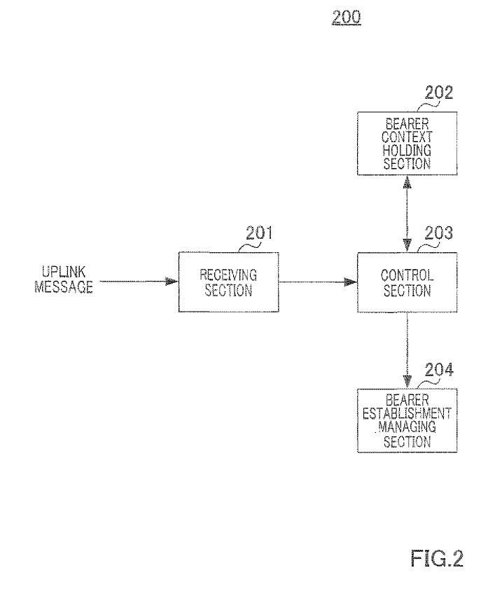

FIG. 2 shows a configuration of the network node according to the present embodiment.

In network node 200 shown in FIG. 2, receiving section 201 receives the uplink message that is transmitted from UE 100 (FIG. 1). Then, receiving section 201 outputs the received uplink message to control section 203. In this case, the uplink message that is transmitted from UE 100 is an initial message (a service request) that UE 100 transmits at a time of shifting from the idle mode to the connection mode.

Bearer context holding section 202 holds a plurality of bearer contexts including the same bearer contexts as those of bearer context holding section 103 of UE 100. That is, bearer context holding section 202 shares and holds the bearer contexts with bearer context holding section 103 of UE 100.

Control section 203 decides which one of establishment of a signaling connection and establishment of a radio bearer should be performed to UE 100, based on the uplink message (the service request) input from receiving section 201. Specifically, when the service request is the signaling service request, control section 203 decides that a signaling connection should be established. When the service request is the normal service request, control section 203 refers to bearer context holding section 202, and decides that all radio bearers that are shared and held between UE 100 and network node 200 should be established. When the service request is the extended service request, control section 203 refers to bearer context holding section 202, and decides that a radio bearer corresponding to a bearer ID shown in the data status included in the extended service request should be established. Then, control section 203 outputs a result of the decision to bearer establishment managing section 204.

Bearer establishment managing section 204 controls establishment of a signaling connection or establishment of a radio bearer between the bearer establishment managing section 204 and UE 100, based on a result of the decision that is input from control section 203.

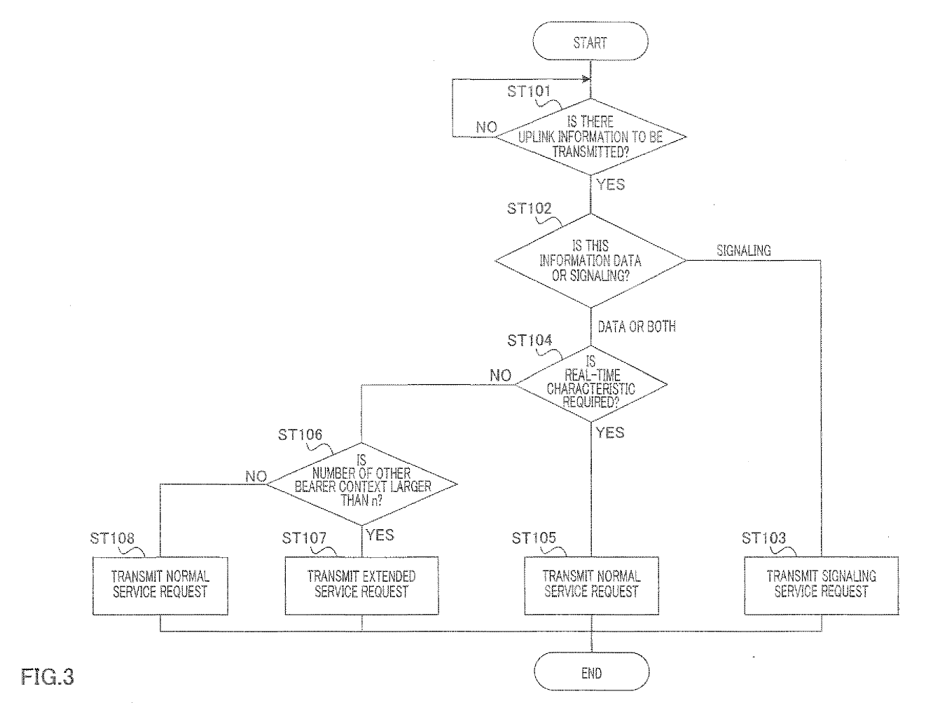

Next, the detail of a transmission process of the service request in UE 100 (FIG. 1) according to the present embodiment is explained. FIG. 3 shows a flow of a transmission process of a service request in UE 100.

In FIG. 3, at Step (hereinafter, “ST”) 101, information deciding section 101 of UE 100 confirms whether uplink information (uplink information in the transmission waiting state) to be transmitted is present. When uplink information to be transmitted is not present (ST 101: NO), that is, when UE 100 is in the waiting state and also in the idle mode, information deciding section 101 repeats ST 101 until when the uplink information to be transmitted is generated.

On the other hand, when uplink information to be transmitted is present (ST 101: YES), information deciding section 101 decides whether this uplink information is uplink signaling, or uplink data at ST 102. When the uplink information is only the uplink signaling (ST 102: signaling), control section 104 generates the signaling service request at ST 103. That is, transmitting section 105 transmits the signaling service request to network node 200.

On the other hand, when the uplink information is either uplink data or both the uplink signaling and the uplink data (ST 102: data or both), QoS deciding section 102 decides whether a real-time characteristic is required in the uplink data at ST 104. When a real-time characteristic is required in the uplink data (ST 104: YES), control section 104 generates the normal service request at ST 105. That is, transmitting section 105 transmits the normal service request to network node 200.

On the other hand, when a real-time characteristic is not required in the uplink data (ST 104: NO), control section 104 refers to bearer context holding section 103 at ST 106, and decides whether the number of bearer contexts (other bearer contexts) other than the bearer context with which the uplink data is associated is larger than a threshold value n set in advance.

When the number of the other bearer contexts is larger than the threshold value n (ST 106: YES), control section 104 generates the extended service request including a data status which shows a bearer ID shown in a specified bearer context at ST 107. That is, transmitting section 105 transmits the extended service request to network node 200.

On the other hand, when the number of the other bearer contexts is equal to or smaller than the threshold value n (ST 106: NO), control section 104 generates the normal service request at ST 108. That is, transmitting section 105 transmits the normal service request to network node 200.

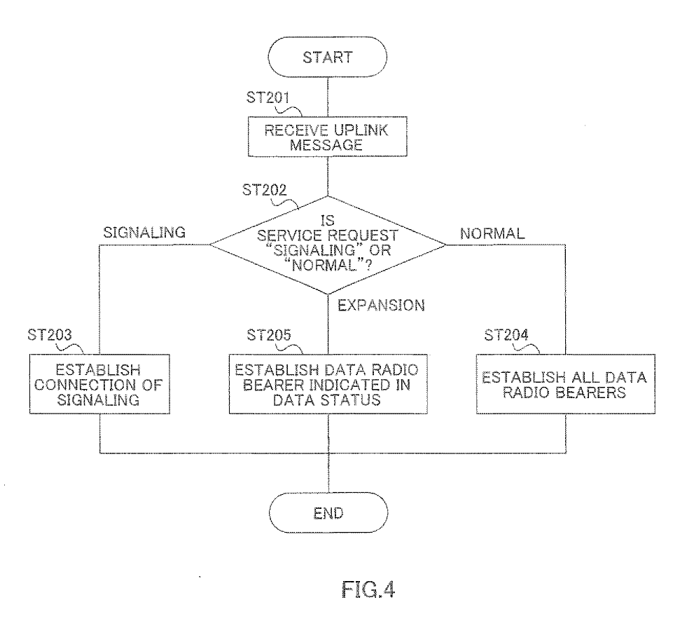

Next, a detail of the process of establishing a radio bearer in network node 200 (FIG. 2) according to the present embodiment is explained. FIG. 4 shows a flow of the process of establishing a radio bearer in network node 200. A decision process of a service request shown in FIG. 4 occurs when UE 100 shifts from the idle mode to the connection mode, that is, when UE 100 has transmitted a service request.

At ST 201, receiving section 201 of network node 200 receives an uplink message (a service request) from UE 100.

At ST 202, control section 203 decides whether the service request received at ST 201 is the signaling service request (whether instruction information for requesting establishment of a signaling connection is included in the service request), the normal service request, or the extended service request.

When the service request is the signaling service request (ST 202: signaling), control section 203 outputs information for instructing establishment of a signaling connection, as a result of the decision, to bearer establishment managing section 204 at ST 203. As a result, bearer establishment managing section 204 establishes only a signaling connection to transmit/receive a control message, without establishing a radio bearer between UE 100 and network node 200.

When the service request is the normal service request (ST 202: normal), control section 203 refers to bearer context holding section 202, and outputs information for instructing establishment of all data radio bearers corresponding to the bearer contexts that are shared and held between UE 100 and network node 200, as a result of the decision, to bearer establishment managing section 204 at ST 204. As a result, bearer establishment managing section 204 immediately establishes all radio bearers corresponding to the bearer contexts that are shared and held between UE 100 and network node 200.

On the other hand, when the service request is the extended service request (ST 202: expansion), control section 203 refers to bearer context holding section 202, and specifies a data radio bearer corresponding to a bearer ID shown in the data status that is included in the extended service request, at ST 205. Control section 203 outputs the information that instructs establishment of only a specified data radio bearer, as a result of the decision, to bearer establishment managing section 204. As a result, bearer establishment managing section 204 establishes only a data radio bearer that UE 100 requests to establish.

As described above, when the uplink information is generated, UE 100 generates a service request based on the uplink information, and transmits the generated service request to network node 200. That is, UE 100 selects a method of establishing a signaling connection or a method of establishing a radio bearer, based on the uplink information.

Specifically, when the uplink information is the uplink signaling (ST 102: signaling), UE 100 transmits the signaling service request (ST 103). As a result, network node 200 establishes only a signaling connection, without establishing a radio bearer between UE 100 and network node 200 (ST 203). That is, when the uplink signaling is generated, UE 100 selects a method of establishing a signaling connection for establishing only a signaling connection, without establishing a radio bearer. As a result, because a data radio bearer is not established, efficiency of the use of a radio resource can be improved.

Further, when the uplink information is the uplink data (ST 102: data) and when a real-time characteristic is required in the uplink data (ST 104: YES), UE 100 transmits the normal service request (ST 105) in a similar manner to that of the LTE. Therefore, network node 200 can quickly establish a radio bearer, by immediately establishing all radio bearers corresponding to bearer contexts that are shared and held between UE 100 and network node 200 (ST 204). That is, when a real-time characteristic is required in the uplink data, UE 100 selects a method of establishing a radio bearer for establishing a radio bearer such that an establishment speed of a radio bearer is improved with first priority. As a result, an establishment speed of a radio bearer can be improved.

On the other hand, when the uplink information is the uplink data (ST 102: data or both) and also when a real-time characteristic is not required in the uplink data (ST 104: YES), it is preferable that UE 100 selects a method of establishing a radio bearer for establishing a radio bearer such that efficiency of the use of a radio resource is improved with first priority. However, in UE 100, there is a case where improvement effect of efficiency of the use of a radio resource cannot be sufficiently obtained, depending on the number of bearer contexts (the other bearer contexts) other than a bearer context with which uplink data is associated.

For example, it is assumed that a case where eight bearer contexts are shared and held between UE 100 and network node 200. In this case, when the number of a bearer context corresponding to the uplink data is one, the number of remaining bearer contexts (that is, the other bearer contexts described above) becomes seven. In this case, since a proportion of the seven bearer contexts to all bearer contexts is relatively large, so that the improvement effect of efficiency of the use of a radio resource due to no establishment of the seven bearer contexts for which establishment of a radio bearer is unnecessary is large. On the other hand, it is assumed that a case where four bearer contexts are shared and held between UE 100 and network node 200, for example. When the number of bearer contexts corresponding to the uplink data is three, the number of remaining bearer contexts (that is, the other bearer contexts described above) becomes one. In this case, since a proportion of the one bearer context to all bearer contexts is relatively small, so that the improvement effect of efficiency of the use of a radio resource due to no establishment of the one bearer context for which establishment of a radio bearer is unnecessary is small. As described above, the improvement effect of efficiency of the use of a radio resource due to no establishment of a radio bearer corresponding to the other bearer contexts other than the bearer context specified by UE 100 is different depending on the number of the other bearer contexts.

As a result, in the present embodiment, when a real-time characteristic is not required in the uplink data, UE 100 further decides whether the number of the other bearer contexts is larger than the threshold value n. When the number of other bearer contexts is larger than the threshold value n (ST 106: YES, that is, the improvement effect of efficiency of the use of a radio resource is large), UE 100 transmits the extended service request including a data status concerning the uplink data (ST 107). As a result, network node 200 establishes only a data radio bearer corresponding to the uplink data between UE 100 and network node 200 (ST 205). That is, a radio bearer that is not used (a radio bearer corresponding to the other bearer contexts) between UE 100 and network node 200 is not established, and establishment of a wasteful radio bearer is not generated. That is, when the uplink information is the uplink data and also when a real-time characteristic is not required in the uplink data and when the number of the other bearer contexts is larger than the threshold value n, UE 100 selects a method of establishing a radio bearer for establishing a radio bearer such that efficiency of the use of a radio resource is improved with first priority. As a result, since a radio bearer that is not used between network node 200 and UE 100 is not established, so that efficiency of the use of a radio resource can be improved.

On the other hand, when the number of the other bearer contexts is equal to or smaller than the threshold value n (ST 106: NO, that is, when the improvement effect of efficiency of the use of a radio resource is small), UE 100 transmits the normal service request (ST 108). As a result, network node 200 immediately establishes all radio bearers corresponding to a plurality of bearer contexts that are shared and held between UE 100 and network node 200 (ST: 204), thereby quickly establishing the radio bearers. However, when the number of the other bearer contexts is equal to or smaller than the threshold value n, the number of radio resources that are wastefully used is small even when all radio bearers are established. Therefore, influence of the wastefully-used radio resources on a reduction of efficiency of the use of a radio resource is small. Therefore, when the uplink information is uplink data and also when a real-time characteristic is not required in the uplink data and when the number of the other bearer contexts is equal to or smaller than the threshold value n, UE 100 selects a method of establishing a radio bearer for establishing a radio bearer so as to obtain improvement effect of an establishment speed of a radio bearer with priority, rather than improvement effect of efficiency of the use of a radio resource. As a result, the establishment speed of a radio bearer can be improved.

That is, in UE 100 and network node 200, when the uplink information is the uplink data and when a real-time characteristic is not required in the uplink data and also when the number of the other bearer contexts is larger than the threshold value, only a radio bearer corresponding to the uplink data is established. Therefore, improvement effect of efficiency of the use of a radio resource can be obtained with priority. Therefore, in this case, since radio bearers that are established between UE 100 and network node 200 can be set to a minimum requirement, so that power consumption in UE 100 can be reduced.

Further, in UE 100 and network node 200, when the uplink information is uplink data and also when a real-time characteristic is required in the uplink data, or when the uplink information is uplink data and when a real-time characteristic is not required in the uplink data and also when the number of the other bearer contexts is equal to or smaller than the threshold value, all radio bearers including radio bearers corresponding to the uplink data are immediately established. Therefore, in this case, improvement effect of the establishment speed of a radio bearer can be obtained with priority.

Therefore, according to the present embodiment, even when the UE and the network node hold a plurality of bearer contexts, when a real-time characteristic is not required in the uplink data, power consumption of the UE can be reduced by improving efficiency of the use of a radio resource. According to the present embodiment, when a real-time characteristic is required in the uplink data, a radio bearer can be quickly established in a similar manner to that of the LTE. Further, according to the present embodiment, in a case of transmitting uplink signaling, a data radio bearer is not established. Therefore, radio resource efficiency can be improved.

Further, according to the present embodiment, even when a real-time characteristic is not required in the uplink data, when the number of the other bearer contexts other than the bearer context with which the uplink data is associated is equal to or smaller than the threshold value, the establishment speed of a radio bearer can be improved with priority, rather than improvement of efficiency of the use of a radio resource.

In the present embodiment, a case is explained where the UE generates the extended service request or the normal service request, depending on whether the number of bearer contexts (the other bearer contexts) other than the bearer context with which the uplink data in the transmission waiting state is associated is larger than the threshold value n, out of a plurality of bearer contexts that are held by the own apparatus. However, in the present invention, it is sufficient that the UE can evaluate whether it is useful to include a data status in the service request to reduce wasteful use of a radio resource (improvement of efficiency of the use of a radio resource), in not only a case of deciding whether the number of the other bearer contexts is larger than the threshold value n. For example, the UE may decide whether a total value of the QoS of the other bearer contexts is larger than the threshold value. Alternatively, the UE may decide whether a total value of bandwidths that the radio bearers corresponding to the other bearer contexts use is equal to or larger than the threshold value.

Further, a threshold value of the number of the other bearer contexts (or a total value of bandwidths, a total of QoS) can be set to an optimum value that is determined by a UE manufacturer or a communication service provider. For example, the above threshold value can be set by analyzing detailed statistics in an actual communication environment, taking into consideration a balance between a time required for a signaling connection or a radio bearer to be established (an establishment speed) and efficiency of the use of a radio resource. Further, a communication service provider can perform signaling on a threshold value using an ATTACH ACCEPT message or a TAU ACCEPT message.

### Embodiment 2

In the present embodiment, a case where downlink information (downlink signaling or downlink data) is generated in a network node is explained. That is, the network node transmits paging information for notifying presence of downlink information, to the UE.

In the LIE, no information is included in the paging information that is transmitted from the network node (for example P-GW (PDN-Gateway)) to the UE. Therefore, the UE cannot recognize a purpose that is paged by the network node. Accordingly, upon receiving the paging information, the UE transmits a service request that does not include a service time and an uplink data status, as described above. Consequently, the network node cannot recognize whether the UE is requesting establishment of a radio bearer, or is responding to the paging information. As a result, between the UE and the network node, when the network node holds a plurality of bearer contexts, radio bearers corresponding to all bearer contexts are established each time when a service request is transmitted. As a result, since unnecessary radio bearers other than the radio bearer that is actually used are also established, efficiency of the use of a radio resource becomes poor.

In the present embodiment, the network node transmits paging information including instruction information that is generated based on the downlink information to the UE.

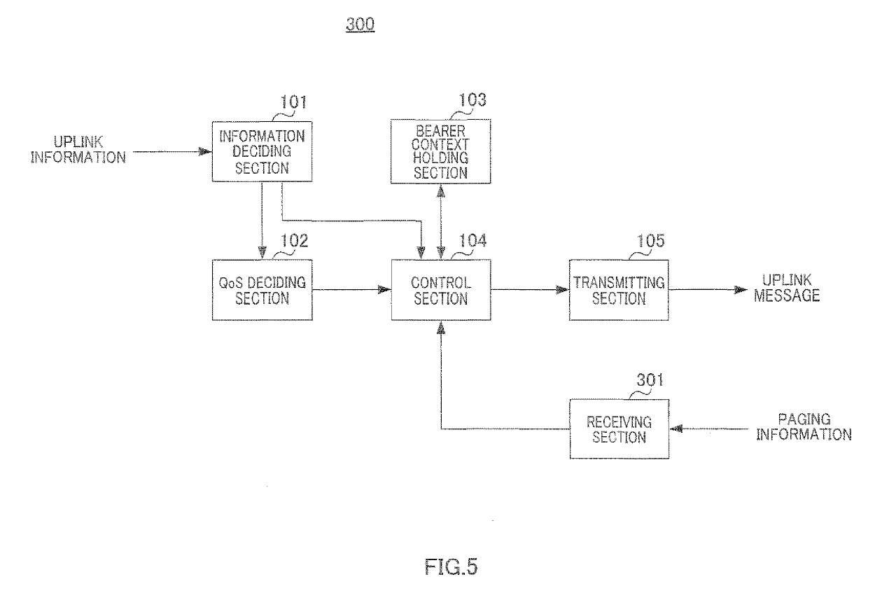

FIG. 5 is a block diagram showing a configuration of UE 300 according to the present embodiment. In FIG. 5, constituent elements that are the same as those of UE 100 (FIG. 1) explained in Embodiment 1 are attached with the same reference symbols, and their explanation is not repeated.

Receiving section 301 receives paging information that is transmitted from network node 400 described later, and outputs the received paging information to control section 104.

When the paging information is input from receiving section 301, control section 104 generates a service request based on the instruction information included in the paging information.

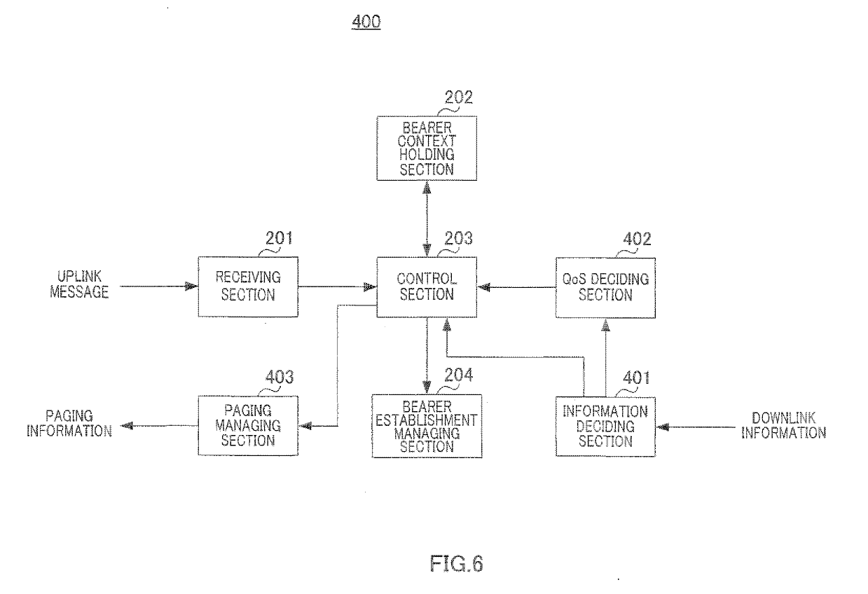

FIG. 6 is a block diagram showing a configuration of network node 400 according to the present embodiment. In FIG. 6, constituent elements that are the same as those of network node 200 (FIG. 2) explained in Embodiment 1 are attached with the same reference symbols, and their explanation is not repeated. In the present embodiment, network node 400 shown in FIG. 6 is a radio communication apparatus according to the present invention.

Information deciding section 401 decides whether input downlink information, that is, downlink information in the transmission waiting state that is destined to UE 300, is downlink signaling or downlink data. When the downlink information is downlink signaling, information deciding section 401 outputs information indicating that the downlink signaling is in the transmission waiting state, to control section 203. On the other hand, when the downlink information is downlink data, information deciding section 401 outputs information indicating that the downlink data is in the transmission waiting state, to QoS deciding section 402.

When the information indicating that the downlink data is in the transmission waiting state is input from information deciding section 401, QoS deciding section 402 decides whether a real-time characteristic is required in the downlink data, based on the QoS of the downlink data, in a similar manner to that of QoS deciding section 102 in Embodiment 1. Then, QoS deciding section 402 outputs to control section 203, QoS information that indicates a result of the decision about whether a real-time characteristic is required in the downlink data.

Control section 203 generates instruction information to be included in the paging information that is transmitted to UE 300, based on the information input from information deciding section 401 or QoS deciding section 402. Specifically, when the information indicating that the downlink signaling is in the transmission waiting state is input from information deciding section 401, control section 203 generates signaling instruction information indicating that the downlink signaling is present.

On the other hand, when the QoS information is input from QoS deciding section 402, control section 203 decides that the downlink data is in the transmission waiting state. Then, control section 203 refers to bearer context holding section 202, and decides whether a bearer context that indicates information on a data radio bearer corresponding to the downlink data is already known. When a bearer context corresponding to the downlink data cannot be specified (when a bearer context corresponding to the downlink data is unknown), control section 203 generates default bearer instruction information for instructing establishment of a default bearer. When network node 400 receives the default bearer service request from UE 300 after network node 400 transmits paging information that includes the default bearer instruction information, control section 203 instructs bearer establishment managing section 204 to establish a default bearer.

On the other hand, when a bearer context corresponding to the downlink data is specified (when a bearer context corresponding to the downlink data is already known), control section 203 further generates instruction information based on QoS information (that is, a result of the decision as to whether a real-time characteristic is required in the downlink data). Specifically, when a real-time characteristic is required in the downlink data, control section 203 generates real-time instruction information indicating that the downlink data that requires a real-time characteristic is present. On the other hand, when a real-time characteristic is not required in the downlink data, control section 203 generates bearer ID instruction information indicating a bearer ID that is included in a specified bearer context. For example, the bearer ID instruction information is coded as one-byte information. Then, control section 203 outputs the generated instruction information to paging managing section 403.

Paging managing section 403 generates paging information including the instruction information that is input from control section 203, and transmits the generated paging information to UE 300.

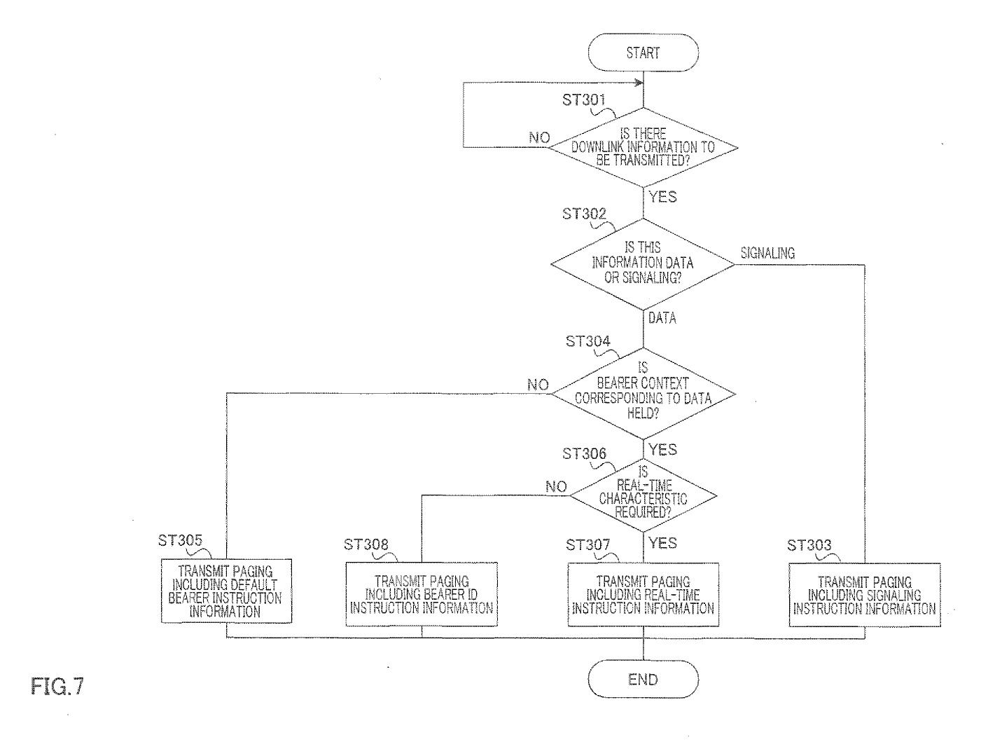

Next, a detail of a transmission process of the paging information in network node 400 (FIG. 6) according to the present embodiment is explained. FIG. 7 shows a flow of a generation process of the instruction information in network node 400.

In FIG. 7, at ST 301, information deciding section 401 of network node 400 confirms whether downlink information to be transmitted (downlink information in the transmission waiting state) is present. When downlink information to be transmitted is not present (ST 301: NO), information deciding section 401 repeats the process of ST 301 until when downlink information to be transmitted is generated.

On the other hand, when downlink information to be transmitted is present (ST 301:YES), information deciding section 401 decides whether the downlink information is downlink signaling or downlink data at ST 302. When the downlink information is downlink signaling (ST 302: signaling), control section 203 generates signaling instruction information at ST 303. That is, paging managing section 403 transmits paging information that includes the signaling instruction information, to UE 300.

On the other hand, when the downlink information is downlink data (ST 302: data), control section 203 refers to bearer context holding section 202, and decides whether a bearer context corresponding to the downlink data is already known at ST 304. That is, control section 203 decides whether bearer context holding section 202 holds a bearer context corresponding to the downlink data that is decided at ST 302. When a bearer context corresponding to the downlink data is unknown (ST 304: NO), control section 203 generates default bearer instruction information at ST 305. That is, paging managing section 403 transmits paging information that includes default bearer instruction information, to UE 300.

On the other hand, when a bearer context corresponding to the downlink data is already known (ST 304: YES), control section 203 decides whether a real-time characteristic is required in the downlink data, based on QoS information that is input from QoS deciding section 402, at ST 306. When a real-time characteristic is required in the downlink data (ST 306: YES), control section 203 generates real-time instruction information at ST 307. That is, paging managing section 403 transmits paging information that includes the real-time instruction information, to UE 300.

On the other hand, when a real-time characteristic is not required in the downlink data (ST 306: NO), at ST 308, control section 203 generates bearer ID instruction information indicating a bearer ID that is included in the bearer context corresponding to the downlink data specified at ST 304. That is, paging managing section 403 transmits the paging information that includes bearer ID instruction information, to UE 300.

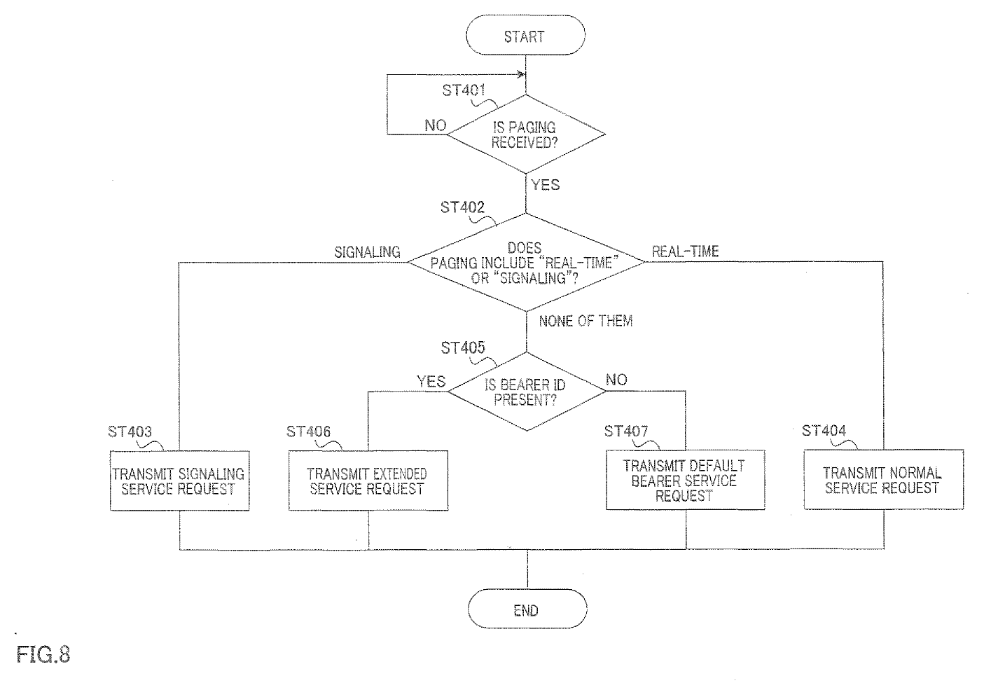

Next, a detail of a transmission process of the service request in UE 300 (FIG. 5) according to the present embodiment is explained. FIG. 8 shows a flow of a transmission process of the service request in control section 104 of UE 300.

At ST 401, receiving section 301 of UE 300 confirms whether paging information transmitted from network node 400 is input. When the paging information is not input (ST 401: NO), receiving section 301 repeats the process at ST 401 until when the paging information is input.

When the paging information is input (ST 401: YES), control section 104 decides whether the instruction information included in the paging information is signaling instruction information, or real-time instruction information, at ST 402. When the instruction information is the signaling instruction information (ST 402: signaling), control section 104 generates a signaling service request at ST 403. That is, transmitting section 105 transmits the signaling service request to network node 400. As a result, network node 400 establishes only a signaling connection to be able to transmit/receive a control message, without establishing a radio bearer between UE 300 and network node 400.

When the instruction information is the real-time instruction information (ST 402: real-time), control section 104 generates the normal service request at ST 404. That is, transmitting section 105 transmits the normal service request to network node 400. As a result, network node 400 immediately establishes all radio bearers corresponding to bearer contexts that are shared and held between UE 300 and network node 400.

On the other hand, when the instruction information is neither the signaling instruction information nor the real-time instruction information (ST 402: none of the information), control section 104 decides whether a bearer ID instruction information is included in the paging information at ST 405.

When the bearer ID instruction information is included in the paging information (ST 405: YES), control section 104 refers to a plurality of bearer contexts that are held by bearer context holding section 103, and specifies a data radio bearer corresponding to the bearer ID indicated by the bearer ID instruction information, at ST 406. Then, control section 104 generates the extended service request that includes a data status concerning the specified data radio bearer. That is, transmitting section 105 transmits the extended service request to network node 400. As a result, network node 400 establishes only a data radio bearer that UE 300 requests to establish. UE 300 transmits the extended service request including the data status based on the bearer ID instruction information when receiving the paging information including the bearer ID instruction information, because there is a possibility that uplink data in the transmission waiting state corresponding to a separate radio bearer is present in UE 300. That is, by referring to the data status that is included in the extended service request, network node 400 can distinguish whether the service request is a service request corresponding to the paging information, or a service request corresponding to the uplink data of UE 300.

On the other hand, when the bearer ID instruction information is not included in the paging information (ST 405: NO), that is, when the instruction information is default bearer instruction information, control section 104 generates the default bearer service request including the default bearer instruction information at ST 407. That is, control section 104 recognizes that downlink data corresponding to the paging information is new data, and that the downlink data does not hold a bearer context corresponding to the downlink data. Transmitting section 105 transmits the default bearer service request to network node 400. As a result, network node 400 establishes only a default hearer that UE 300 requests to establish. In order to notify to network node 400 that uplink data in the transmission waiting state is not present in UE 300, UE 300 transmits the default bearer service request when receiving the paging information including the default bearer instruction information.

As explained above, when downlink information is generated, network node 400 generates instruction information based on the downlink information, and transmits paging information including the generated instruction information to UE 300. That is, network node 400 selects a method of establishing a signaling connection or a method of establishing a radio bearer, based on the downlink information.

Specifically, when the downlink information is the downlink signaling (ST 302: signaling), network node 400 transmits the paging information including the signaling instruction information (ST 303). As a result, UE 300 transmits the signaling service request (ST 403). Therefore, only a signaling connection is established between UE 300 and network node 400, without establishing a radio bearer. That is, when the downlink signaling is generated, network node 400 selects a method of establishing a signaling connection for establishing only a signaling connection, without establishing a radio bearer. As a result, since a data radio bearer is not established, efficiency of the use of a radio resource can be improved.

In the downlink, there may be a case that downlink data in which network node 400 is associated with an unknown bearer context is generated. Therefore, when the downlink information is downlink data (ST 302: data), and also when the bearer context corresponding to the downlink data is unknown (ST 304: NO), network node 400 transmits the paging information including the default bearer instruction information (ST 305). As a result, UE 300 transmits the default bearer service request (ST 407). Therefore, only a default bearer is established between UE 300 and network node 400. That is, even when a bearer context corresponding to the downlink data is unknown, network node 400 can minimize a radio bearer that is established between UE 300 and network node 400, by selecting a method of establishing a radio bearer for establishing only a default bearer set in advance. As a result, since the radio bearer that is established between UE 300 and network node 400 can be minimized, power consumption in UE 300 can be reduced.

When the downlink information is downlink data (ST: 302:data) and also when a bearer context corresponding to the downlink data is already known (ST 304:YES), and also when a real-time characteristic is required in the downlink data (ST 306:YES), network node 400 transmits paging information including real-time instruction information (ST 307). As a result, UE 300 transmits the normal service request (ST 404). Consequently, a radio bearer can be quickly established between UE 300 and network node 400. That is, when a real-time characteristic is required in the downlink data, network node 400 selects a method of establishing a radio bearer for establishing a radio bearer such that an establishment speed of the radio bearer is improved with first priority. As a result, the establishment speed of a radio bearer can be improved.

When the downlink information is downlink data (ST 302:data) and also when a bearer context corresponding to the downlink data is already known (ST 304:YES), and also when a real-time characteristic is not required in the downlink data (ST 306:NO), network node 400 transmits paging information including bearer ID instruction information (ST 308). As a result, UE 300 transmits the extended service request (ST 406). Consequently, only a radio bearer corresponding to the bearer context specified by network node 400 is established between UE 300 and network node 400. That is, when a real-time characteristic is not required in the downlink data, network node 400 selects a method of establishing a radio bearer for establishing a radio bearer such that efficiency of the use of a radio resource is improved with first priority. As a result, since a radio bearer that is not used between network node 400 and UE 300 is not established, efficiency of the use of a radio resource can be improved. Consequently, since a radio bearer that is established between UE 300 and network node 400 can be set to a minimum requirement, power consumption in UE 300 can be reduced.

As described above, according to the present embodiment, even when the UE and the network node hold a plurality of bearer contexts, but when a real-time characteristic is not required in the downlink data, it is possible to improve efficiency of the use of a radio resource and reduce power consumption of the UE, in a similar manner to that in Embodiment 1. Further, according to the present embodiment, when a real-time characteristic is required in the downlink data, a radio bearer can be quickly established in a similar manner to that of the LTE.

Further, according to the present embodiment, when the downlink signaling is transmitted, efficiency of a radio resource can be improved without establishing a data radio bearer. For example, in order to change the UE into a separate network (MME: Mobility Management Entity), it is considered that the network (MME) releases a connection of S1 signaling and also requests UE 300 to retransmit a TAU for executing load balancing. At this time, the network node transmits to the UE, paging information that includes signaling instruction information for instructing execution of the load balancing. Then, the UE transmits the signaling service request, when there is no uplink data that the own apparatus transmits. As a result, it is possible to establish only a signaling connection without establishing a radio bearer between the UE and the network node.

Further, according to the present embodiment, when a bearer context corresponding to the downlink data is unknown, the network node can improve efficiency of the use of a radio resource by establishing only a default bearer. In this case, for example, after establishing the default bearer, the UE may establish only a specific radio bearer corresponding to the uplink data, in a similar manner to that in Embodiment 1, based on a QoS required by an application for use. As a result, only the radio bearer that is necessary for the application for use can be established between the UE and the network node.

In the present embodiment, a case has been explained where the network node explicitly instructs a signaling connection, establishment of a default bearer, or a request for a real-time characteristic, by using signaling instruction information, default bearer instruction information, or real-time instruction information. However, in the present invention, the network node does not necessarily use real-time instruction information when instructing a request for a real-time characteristic, for example. For example, the network node may implicitly instruct a request for a real-time characteristic, by not including the signaling instruction information and the default bearer instruction information in the paging information. This is much the same for a case of implicitly instructing establishment of a signaling connection, and establishment of a default bearer.

In the present invention, the UE may decide a type of instruction information that is included in the paging information, by using, for example, a switch logic, without being limited to a generation process of the service request shown in FIG. 8. That is, the UE may switch a service request to be generated, depending on which any one of the signaling instruction information, the real-time instruction information, the bearer ID instruction information, and the default bearer instruction information is included in the paging information.

Each embodiment of the present invention is explained above.

In the above embodiments, in order to simplify the explanation, a case has been explained where network node 200 is used by collecting networking functions at a network side as one apparatus. However, in the present invention, the functions of network node 200 described above can be executed by a plurality of mutually different apparatuses. For example, in the LTE, the functions of network node 200 may be executed by dividing the functions into the MME and the packet gateway.

Further, in the above embodiment, as one of the examples, a case has been explained where the UE (QoS deciding section 102) or the network node (QoS deciding section 402) decides whether a real-time characteristic is required in the uplink data or the downlink data by referring to a TOS field of an IP packet. However, in the present invention, the UE or the network node may decide whether a real-time characteristic is required in the uplink data or the downlink data, based on the QoS information that is explicitly provided by an application in which the uplink data or the downlink data is used, for example. Further, the UE or the network node may decide whether a real-time characteristic is required in the uplink data or the downlink data, by specifying whether a protocol to be used is a real-time application (for example, VoIP), by executing a deep packet inspection to the uplink data or the downlink data. Alternatively, the UE or the network node may decide whether a real-time characteristic is required in the uplink data or the downlink data, based on either a protocol type of the application (for example, RTP (Real-time Transport Protocol) or SCTP (Stream Control Transmission Protocol)).

In the above embodiments, a case has been explained where a “signaling service request” that includes only instruction information indicating a request for a signaling connection is used. However, in the present invention, the UE may transmit the instruction information that indicates a request for a signaling connection, as an information element of option composed of some bits (four bits or eight bits), by including the instruction information in the “normal service request” described above, instead of the “signaling service request”. Accordingly, the network node can decide that the UE requests a signaling connection, by referring to the information element of option included in the “normal service request”.

Further, in the above embodiments, a case has been explained where the “extended service request” that includes a data status concerning the uplink data in the transmission waiting state is used. However, in the present invention, the LIE may transmit the instruction information that indicates a data status, as an information element of option, by including the instruction information in the “normal service request” described above, instead of the “extended service request”. Accordingly, the network node can decide a specific radio bearer that needs to be established, by referring to the information element of option that is included in the “normal service request”.

Further, in the above embodiments, a case has been explained where the “default bearer service request” that includes only the instruction information indicating a request for establishing a default bearer, is used. However, in the present invention, the UE may transmit the instruction information that indicates a request for establishing a default bearer, as an information element of option, by including the instruction information in the “normal service request” described above or in the “extended service request” described above, instead of the “default bearer service request”. Accordingly, the network node can decide a specific radio bearer that needs to be established, by referring to the information element of option that is included in the “normal service request” or in the “extended service request”.

Further, in the above embodiments, a case has been explained where, when the UE transmits the extended service request, only a radio bearer that is indicated in the data status included in the extended service request is established between the UE and the network node. However, in the present invention, when transmitting the extended service request, the UE may establish all radio bearers (radio bearers to connect the same PDN (Packet Data Network)) belonging to the application that is the same as the radio bearers indicated in the data status included in the extended service request, out of a plurality of radio bearers corresponding to the bearer contexts that the UE and the network node share and hold.

In the present invention, the network node is included in a wireless network, for example, and a cellular network or a WLAN (Wireless Local Area Network) is exemplified as a wireless network.

In the present invention, a combination of Embodiment 1 and Embodiment 2 can be implemented. That is, when uplink information in the transmission waiting state is generated in the UE, the UE decides an uplink information type and a real-time characteristic of the uplink information, and generates a service request (that is, a method of establishing a signaling connection or a method of establishing a connection of a radio bearer is selected) according to a result of the decision, in a similar manner to that in Embodiment 1. That is, when uplink information in the transmission waiting state is generated in the UE, the UE operates as the radio communication apparatus according to the present invention, in a similar manner to that in Embodiment 1. On the other hand, when downlink information in the transmission waiting state is generated in the network node, the network node decides a downlink information type and a real-time characteristic of the downlink information, and generates instruction information to be included in the paging information (that is, a method of establishing a signaling connection or a method of establishing a connection of a radio bearer is selected) according to a result of the decision, in a similar manner to that in Embodiment 2. That is, when downlink information in the transmission waiting state is generated in the network node, the network node operates as the radio communication apparatus according to the present invention, in a similar manner to that in Embodiment 2. As a result, even when any one of the uplink information and the downlink information is generated, effects similar to those in the above embodiments can be obtained.

The present invention includes the disclosures of the specification, the drawings, and the abstract of Japanese Patent Application No. 2009-190212 filed on Aug. 19, 2009, the entire content of which being incorporated herein by reference.

### INDUSTRIAL APPLICABILITY

The present invention can be applied to a mobile communication system and the like in which a radio terminal apparatus, such as a portable telephone, in the idle mode performs establishment of a signaling connection and establishment of a data radio bearer.

### REFERENCE SIGNS LIST

100, 300 UE
200, 400 Network node
101, 401 Information deciding section
102, 402 QoS deciding section
103, 202 Bearer context holding section
104, 203 Control section
105 Transmitting section
201, 301 Receiving section
204 Bearer establishment managing section
403 Paging managing section

1. A radio communication apparatus in a radio communication system that performs a transmission/reception of data by establishing a radio bearer, comprising:
a first deciding section that decides whether a type of transmission information is signaling or data;
a second deciding section that decides whether a real-time characteristic is required in the transmission information, based on a quality of service (QoS) of the transmission information, when the type is data; and
a selecting section that selects a first establishing method of establishing only a connection of the signaling without establishing the radio bearer between the radio communication apparatus and the other communication apparatus, when the type is signaling, and selects either a second establishing method of establishing the radio bearer that can obtain an establishment speed with first priority, or a third establishing method of establishing the radio bearer that can obtain efficiency in the use of a radio resource with first priority, based on a result of the decision by the second deciding section, when the type is data.

2. The radio communication apparatus according to claim 1, wherein
the selecting section selects either the second establishing method of immediately establishing all of a plurality of the radio bearers that are shared between the radio communication apparatus and the other communication apparatus, or the third establishing method of establishing only a radio bearer corresponding to the transmission information out of the plurality of radio bearers, based on the result of the decision of the second deciding section, when the type is data.

3. The radio communication apparatus according to claim 1, wherein
the selecting section selects the second establishing method when a real-time characteristic is required in the transmission information, and selects the third establishing method when a real-time characteristic is not required in the transmission information.

4. The radio communication apparatus according to claim 1, further comprising a third deciding section that decides whether the number of other bearer contexts other than bearer contexts corresponding to the transmission information is larger than a threshold value, out of bearer contexts that indicate information concerning the plurality of radio bearers, wherein
the selecting section selects the second establishing method, when the type is data and when a real-time characteristic is required in the transmission information, and also when the type is data, when a real-time characteristic is not required in the transmission information, and when the number of the other bearer contexts is equal to or smaller than the threshold value, and
selects the third establishing method when the type is data, when a real-time characteristic is not required in the transmission information, and when the number of the other bearer contexts is larger than the threshold value.

5. The radio communication apparatus according to claim 1, further comprising a fourth deciding section that decides whether a bearer context that indicates information concerning the radio bearer corresponding to the transmission information is already known, wherein
the selecting section selects a fourth establishing method of establishing a radio bearer that is set in advance, when the type is data and also when the bearer context is unknown,
selects the second establishing method when the type is data, when the bearer context is already known, and when a real-time characteristic is required in the transmission information, and
selects the third establishing method when the type is data, when the bearer context is already known, and when a real-time characteristic is not required in the transmission information.

6. The radio communication apparatus according to claim 1, wherein the radio communication apparatus is a radio terminal apparatus or a network node.

7. A radio communication method in a radio communication apparatus that performs a transmission/reception of data by establishing a radio bearer, comprising:
a first deciding step of deciding whether a type of transmission information is signaling or data;
a second deciding step of deciding whether a real-time characteristic is required in the transmission information, based on a quality of service (QoS) of the transmission information, when the type is data; and
a selecting step of selecting a first establishing method of establishing only a connection of the signaling without establishing the radio bearer between the radio communication apparatus and the other communication apparatus, when the type is signaling, and
selecting either a second establishing method of establishing the radio bearer that can obtain an establishment speed with first priority, or a third establishing method of establishing the radio bearer that can obtain efficiency in the use of a radio resource with first priority, based on a result of the decision at the second deciding step, when the type is data.

8. The radio communication method according to claim 7, wherein
the selecting step selects either the second establishing method of immediately establishing all of a plurality of the radio bearers that are shared between the radio communication apparatus and the other communication apparatus, or the third establishing method of establishing only a radio bearer corresponding to the transmission information out of the plurality of radio bearers, based on the result of the decision at the second deciding step, when the type is data.
